(19) United States
(12) Patent Application Publication
(10) Pub. No.: US 2009/0183750 A1
(43) Pub. Date: Jul. 23, 2009

(54) Eyebrow shaping kit

(76) Inventor: Alvina Yvonne Platt-Gregory, Willingboro, NJ (US)

Correspondence Address: THE INVENTORS NETWORK, INC., 332 ACADEMY STREET, CARNEGIE, PA, 15106, US

(21) Appl. No.: 12/009,021

(22) Filed: Jan. 17, 2008

(51) Int. Cl. A45D 40/30; B26B 21/00

(52) U.S. Cl. 132/216; 132/319; 30/34.05

(57) ABSTRACT

An eyebrow shaping kit for shaping and forming eyebrows in unique and individual styles includes a plurality of eyebrow patterns that can be placed upon the eyebrows and temporarily held in position on the eyebrows, and at least one disposable razor for removing the portions of the eyebrows that are not covered by the particular pattern. Each eyebrow pattern has a unique contour or outline so that various forms and shapes for the eyebrows can be obtained. After one eyebrow is appropriately shaped, that eyebrow pattern is simply lifted off the eyebrow, flipped over and placed on the other eyebrow so that the trimming and shaping process can be repeated on the second eyebrow.

### FIELD OF THE INVENTION

The present invention pertains to cosmetic enhancement devices, and more particularly pertains to eyebrow patterns for placement upon the eyebrows so that the eyebrows can be uniquely and individually outlined, shaped and formed.

### BACKGROUND OF THE INVENTION

The cosmetic and personal grooming industry is a multibillion-dollar industry that supplies products and services to men and women, adults and children for maintaining, altering, improving and enhancing every aspect of their physical appearance. From hair salons to spas, botox treatments to plastic surgery, the cosmetic and personal grooming industry caters to our concerns for maintaining, improving or changing our physical appearance. As the face is the most noticeable and distinguishable characteristic in the presentation of one's physical appearance, innumerable devices, systems, and methods have been conceived to maintain, improve and alter the various facial features.

The eyebrows are among the most significant of the facial features and they require continuous care for maintaining an attractive and stylish appearance. Because eyebrows vary from individual to individual in color, thickness, texture, and extension along the brow, various devices have been conceived for their shaping, maintenance, and styling. Tweezers and eyebrow pencils are common devices for shaping, trimming, outlining and coloring the eyebrows. Eyebrow pencils can also simulate eyebrows that are naturally sparse or have been diminished or damaged through accident or illness. However, in order to achieve symmetrically shaped, aesthetically attractive eyebrows often requires more than just tweezers and pencils. Thus, more sophisticated devices have been conceived to shape, outline, and style the eyebrows so that both eyebrows present a uniform and symmetric appearance.

Among the prior art cosmetic devices for shaping or enhancing the eyebrows is the Kimoko Hamada patent (U.S. Pat. No. 3,557,805) that includes an elastic headband for placement about the head and a pair of symmetric eyebrow pieces each of which includes a slit through which a pencil can be inserted for coloring the eyebrows.

The Dyson patent (U.S. Pat. No. 4,118,870) discloses an eyebrow contour guide that includes an alignment member that is placed adjacent to one's nose and an arcuate member pivotally secured to the alignment member and having a slot disposed over the eyebrow for aligning both eyebrows by using scales on the alignment and arcuate member.

The Hirzel patent (U.S. Pat. No. 5,186,190) discloses an eyebrow stencil kit that includes a headband to which wing-shaped stencils are attached with each stencil having one or more cut-outs that are disposed over the respective eyebrow so that the eyebrows can be drawn and shaped.

The Grenevitch et al. patent (U.S. Pat. No. 5,662,129) discloses an eyebrow template that includes a headband to which a template holder is attached, and the template holder includes a pair of slots through which templates are inserted. The templates include slots for guiding the eyebrow pencil in shaping the eyebrows or creating simulated eyebrows.

The Halpern patent (U.S. Pat. No. 5,860,433) discloses an eyebrow forming template that includes a flat backing on which a plurality of right and left eyebrow peel-off templates are affixed. Each template further includes a removable cut-out that when removed reveals a slot whereupon the respective cut-outs for each template are placed over the left and right eyebrows so that the exposed areas can be filled in and shaped by, for example, an eyebrow pencil.

Despite the ingenuity of the above devices, there remains a need for a cosmetic device for shaping, altering and maintaining one's eyebrows that is easy and quick to use, does not require securement about the head and allows the user to transform the eyebrows into a variety of aesthetically appealing shapes and forms.

### SUMMARY OF THE INVENTION

The present invention comprehends on eyebrow shaping kit for outlining and shaping the eyebrows in various unique and individual styles, and is especially useful for individual's desiring to create unique eyebrow shapes and for maintaining their eyebrows at home.

The eyebrow shaping kit includes a plurality of eyebrow patterns or templates, and the eyebrow templates include opposed application surfaces that are able to cling to the eyebrow when moistened. The surfaces contact the eyebrow and skin for holding the eyebrow template in position during outlining, trimming, and shaping of the eyebrow. The eyebrow templates are of a pliable, plastic composition similar to color foam stickers, and the contour of each eyebrow template is unique and different from the contours of the other eyebrow templates. In addition, the eyebrow shaping kit includes at least one plastic disposable razor for shaping, trimming and outlining the eyebrow by shaving off the eyebrow hairs not covered by the eyebrow template. Only one template for each representative shape is needed because after the shaping and outlining of one eyebrow is completed, that particular eyebrow template is lifted off that eyebrow and then flipped over and placed on the other eyebrow.

It is an objective of the present invention to provide an eyebrow shaping kit that allows women to shape and maintain their eyebrows in the comfort and convenience of their home thus avoiding the hassle and expense of frequent salon appointments.

It is another objective of the present invention to provide an eyebrow shaping kit that is quick and easy to use with a minimum of set up and clean up.

It is still another objective of the present invention to provide an eyebrow shaping kit that allows the user to accurately and uniformly shape both eyebrows.

It is still yet another objective of the present invention to provide an eyebrow shaping kit that allows the user to shape and maintain her eyebrows in a convenient and painless manner.

Still another objective of the present invention is to provide an eyebrow shaping kit that is easily adjustable and does not require attachment to or about one's head.

Still yet another objective of the present invention is to provide an eyebrow shaping kit that can be easily manipulated by the user and does not need to be held in position by an adhesive-type tape.

A still further objective of the present invention is to provide an eyebrow shaping kit that can be used by both professional stylists and non-professionals.

Still yet a further objective of the present invention is to provide an eyebrow shaping kit that is a time saving cosmetic enhancement that allows the user to alter the shape of one's eyebrows to suit a particular mood or occasion.

These and other objects, features and advantages will become apparent to one skilled in the art upon a perusal of the following detailed description when read in conjunction with the accompanying drawings and appended claims.

### BRIEF DESCRIPTION OF THE DRAWINGS

FIG. 1 is a perspective view of the eyebrow shaping kit of the present invention and includes in one embodiment for the kit three unique eyebrow patterns and two disposable razors;

FIG. 2 is a front elevational view of an individual with one of the eyebrow patterns shown in FIG. 1 placed upon the left eyebrow of the individual;

FIG. 3 is a sectioned elevational view taken along lines 3-3 of FIG. 2 illustrating the application of the eyebrow pattern to the eyebrow of the individual;

FIG. 4 is a front elevational view of a representative second eyebrow pattern applied to the eyebrow of the individual; and

FIG. 5 is a front elevational view of a third representative eyebrow pattern applied to the eyebrow of the individual.

### DETAILED DESCRIPTION OF THE PREFERRED EMBODIMENT

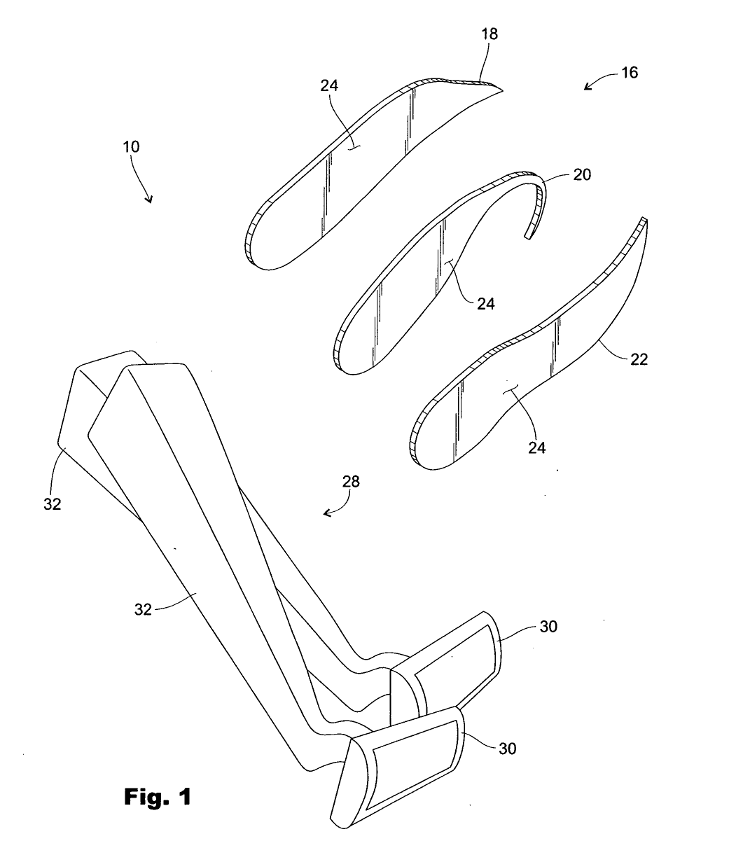

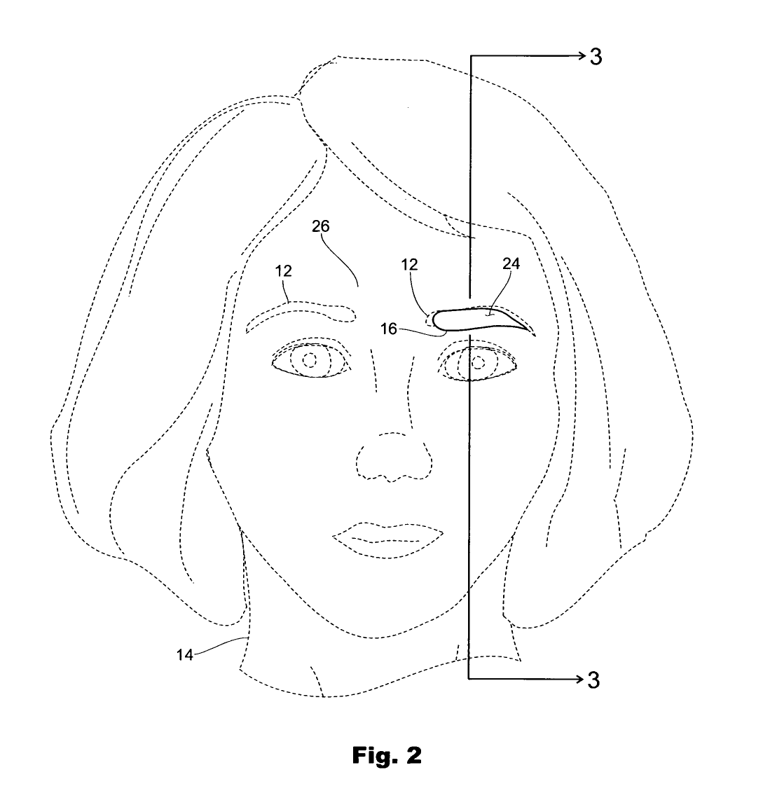

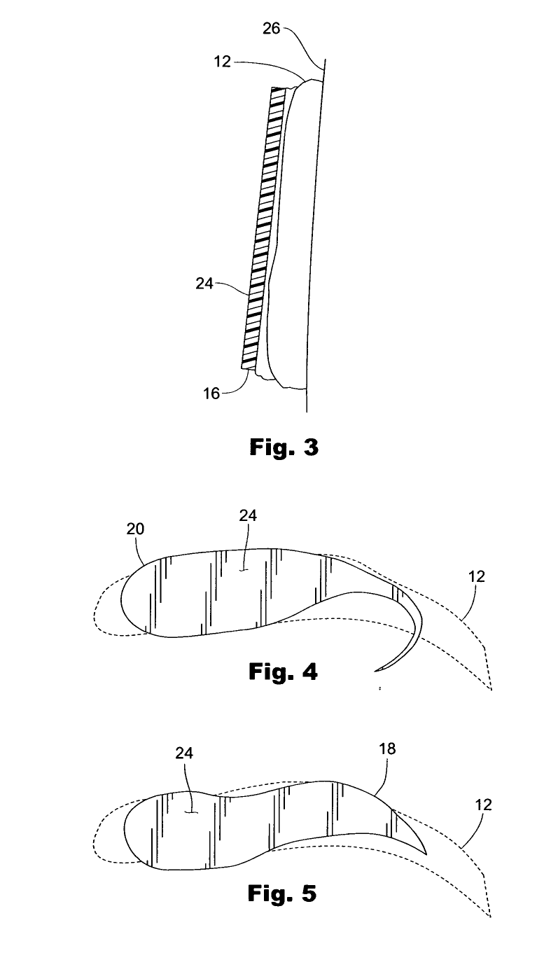

Illustrated in FIGS. 1-5 is an eyebrow shaping kit 10 that includes both a system and a method for trimming, cutting, outlining and shaping the eyebrows 12 of an individual 14 to achieve an attractive and aesthetically appealing appearance as well as for undertaking regular cosmetic maintenance for the eyebrows.

The eyebrow shaping kit 10 of the present invention includes a plurality of eyebrow patterns or templates 16 that are temporarily applicable to and upon the individual's 14 eyebrows 12. The eyebrow templates 16 can come in a variety of geometrical shapes, and three representative shapes or forms are shown in FIG. 1. Thus, one template 18 is elongated and downwardly tapers at one end; a second template 20 is somewhat tear-drop shaped and has a hook-shaped end; and a third representative template 22 is elongated and upwardly tapers at one end. Generally, the eyebrow templates 16 are approximately 2 and ½ inches long to substantially cover the eyebrow 12, and the templates 16 are similar to the commonly used color foam stickers. The eyebrow templates 16 can be clear or opaque and are of a pliable plastic composition for providing both durability and reusability. The templates 16 include opposed flat application surfaces 24 that are capable of temporary adherence to the individual's skin 26. Each application surface 24 presses against and flattens the eyebrows 12 and adheres to the skin 26 when moistened; but the adherence is not of a permanent nature so that the templates 16 can be removed when the trimming and outlining of the eyebrows 12 is completed. Moreover, because both surfaces 24 of the templates 16 are capable of adherence to the skin 26, the need for template pairs is eliminated as each template 16 can be simply flipped over for use on the other eyebrow 12.

In addition, the eyebrow shaping kit 10 of the present invention includes a plurality of preferably plastic disposable razors 28; and in FIG. 1 two razors 28 are shown beside the eyebrow templates 16. The preferred razors 28 will include a one inch long razor head 30 and a three inch long razor handle 32. The small head disposable razors 28 allow for closer and more accurate trimming and outlining of the eyebrows 12, especially around the curved portions of the templates 16 so that only the desired parts of the eyebrows 12 are trimmed, shaped and outlined. The eyebrow shaping kit 10 can include different mixes of eyebrow templates 16 and razors 28: for example, one kit 10 can include three templates 16 and one razor 28; and a second kit 10 can include one template 16 and one razor 28.

Although there are a number of different ways the eyebrow shaping kit 10 can be used, a representative procedure is as follows. The individual 14 would first moisten one eyebrow 12 with warm water and then apply shaving cream to that eyebrow 14. Next, the eyebrow 12 and cream would be flattened and the desired eyebrow template 16 would be selected and placed over and upon the eyebrow 16 for contact with and adherence to the individual's skin 26. The individual 14 would then use short small downward strokes of the razor 28 to remove, shave and trim the uncovered or excess eyebrow hairs. This action will result in the eyebrow 12 taking the form or outline of the particular template 18, 20 or 22, for example, being used. Upon completion of the trimming and outlining of the eyebrow 12, the individual 14 would remove the eyebrow template 16 and wipe the eyebrow 12 clean with a warm cloth in order to remove the shaving cream. Then the individual 14 can outline the eyebrow 12 with alcohol dabbed on a finger or cotton ball. The eyebrow template 16 would then be flipped over and placed on the other eyebrow 12 whereupon the above steps are be repeated. The eyebrow templates 16 thus allow for the uniform, symmetric and accurate shaping and grooming of both eyebrows 12.

Using the eyebrow shaping kit 10 of the present invention further allows one to shape the eyebrows to fit one's mood or disposition on a daily basis. For example, on one day the individual can have full template eyebrows; on the following day half of the eyebrows can be trimmed off; and on the third day one third of the eyebrows can be removed by careful placement of the eyebrow template 16 on the eyebrows.

While the above detailed description describes the preferred embodiment of the present invention, it will be understood that numerous modifications, alterations and variations are possible without deviating from the scope of the appended claims.

I claim:

1. An eyebrow shaping kit for shaping the eyebrows of an individual, comprising:
a plurality of eyebrows templates for removable placement upon the eyebrows to substantially cover the eyebrows;
each eyebrow template having opposed flat application surfaces capable of adhering to the skin of the individual when the application surfaces are moistened with water;
at least one disposable razor for cutting and trimming those portions of the eyebrow that are not covered by the template; and
the eyebrow template capable of being lifted off one eyebrow after that eyebrow has been shaped for placement over and upon the other eyebrow so that both eyebrows can be trimmed and shaped in a uniform and accurate manner;

2. The eyebrow shaping kit of claim 1 wherein the kit can include one razor and three eyebrow templates.

3. The eyebrow shaping kit of claim 2 wherein the kit can include one razor and one eyebrow template.

4. The eyebrow shaping kit of claim 3 wherein the eyebrow templates can include at least one template having an elongated shape and an end that tapers downwardly away from the eyebrow.

5. The eyebrow shaping kit of claim 4 wherein the eyebrow templates can include at least one template having an elongated shape and an end that tapers upwardly and away from the eyebrow.

6. The eyebrow shaping kit of claim 5 wherein the eyebrow template can include at least one template that is elongated in shape and includes a hook-shaped end.

7. An eyebrow shaping kit for trimming and shaping the eyebrows of an individual by placing an eyebrow template upon the eyebrow and using a razor for trimming and shaping the eyebrow, comprises the steps of:
moistening the eyebrow with warm water;
applying shaving cream to the eyebrow;
selecting the eyebrow template for placement upon the eyebrow;
smoothing the eyebrow and the shaving cream;
pressing the eyebrow template against the eyebrow for contact with and adherence to the skin;
cutting off the eyebrow hairs extending about the eyebrow template with short downward strokes of the razor so that the outline of the eyebrow corresponds to the contour of the eyebrow template;
wiping the shaped eyebrow with a warm cloth; and
lifting the eyebrow template off the eyebrow and flipping the eyebrow template over so that the eyebrow template can be placed on the other eyebrow.
